(19) United States
(12) Patent Application Publication
(10) Pub. No.: US 2012/0024236 A1
(43) Pub. Date: Feb. 2, 2012

(54) LIVESTOCK HOUSE

(76) Inventor: JIANN-CHANG LIANG, TAOYUAN (TW)

(21) Appl. No.: 12/873,431

(22) Filed: Sep. 1, 2010

(30) Foreign Application Priority Data
Jul. 29, 2010 (TW) 099214507

(51) Int. Cl. A01K 1/01

(52) U.S. Cl. 119/450

(57) ABSTRACT

An improved livestock house includes a slanted floor, a funnel-shaped ditch coupled to a lower end of the slanted floor, a hole board installed at a connecting position of the slanted floor and the ditch, and a flush pipe installed at the front of the ditch. The slanted floor can make animals to excrete manure with their bottom facing downward involuntarily, and most of the animal's manures together with urines are flushed into the ditch through the hole board and the manures entering into the ditch become smaller, and the smaller manures are collected by the urines or flushed by water in the flush pipe to a lower position of the ditch and then discharged to a wastewater treatment facility. The livestock house maintains a dry environment, improves problems of fermentations and bad smells, removes stinky wastewater, and maximizes the utility to achieve the economic, power-saving and environmental protection effects.

### BACKGROUND OF THE INVENTION

1. Field of the Invention

The present invention relates to an improved livestock house and more particularly to a livestock house with the feature of a simple and economic construction and an excellent dry environment for reducing the occurrence of diseases and the waste of feeds, overcoming the hygiene and sanitation problems of fermentations and bad smells produced by animal manures and urines, and removing stinky wastewater, as well as facilitating the management of the livestock house and maximizing the utility to achieve the economic, power-saving and environmental protection effects that are in compliance with practical requirements of livestock houses.

2. Description of the Related Art

In general, a livestock house is constructed by laying a floor horizontally and building a feeding trough and a drinking water dispenser at the front of the livestock house and a manure removal area at the rear of the livestock house. During the use of the livestock house, a predetermined number of animals are gathered in the same livestock house to facilitate the feeding of the animals and achieve the cleaning and management effects. For example, a pig house as shown in FIG. 1 is generally used for raising pigs which rank No. 1 in quantity among the domestic livestock in the world, and the pig house 1 (or livestock house) is generally in a rectangular shape, and a predetermined space is partitioned into a plurality of adjacent pig pens 11, and the floor 111 of each pig pen 11 is substantially arranged in a horizontal position or slightly tilted backward at the rear of the pig house, and a manure disposal outlet 113 is formed at a connecting position of a floor 111 and a wall 112 (or fence) at the rear of the pig house, and a feeding trough 12 and a drinking water dispenser 13 are arranged at the front side of the pig house and separated from the manure disposal outlet 113 at the rear. In addition, a manure disposal channel 114 is interconnected to an external side of the manure disposal outlet 113 of the pig pen 11 and connected to a wastewater treatment facility (not shown in the figure). During use, the predetermined quantity of pigs gathered in the pig pen 11 can eat and drink at the front of the pig pen 11 and excrete waste products on the floor 111 at the rear of pig pen 11, and this layout facilitates washing and discharging the waste products from the manure disposal outlet 113 to the manure disposal channel 114 and then to the wastewater treatment facility (not shown in the figure). Undeniably, the aforementioned pig house can achieve the purpose of raising a large quantity of pigs, but pig raisers still find the following drawbacks in the practical application of the pig house.

1. Since the floor is horizontal, pigs gathered together may excrete manure and urine and drink water anytime, and the manure and urine and the water dropped out from the drinking water dispenser may not be discharged from the manure disposal outlet quickly or successfully, but they will be accumulated on the floor. With the activities of the pigs, it is not only difficult to maintain the floor dry all the time, but the mixed manure and urine keep making the floor wet. Pig farmers know that the mixed wet manure and urine undergo fermentation easily within a short time and cause irritating bad smells as well as hygiene, sanitation, and disease problems.

2. Since pigs may spill feeds from the feeding trough easily while eating the feeds, the floor is wet and dirty all the time, and the feeds spilled on the floor are wasted, and thus incurring a substantial waste after a long time of use.

3. To improve the aforementioned problem of having a large quantity of wet manure and urine accumulated on the floor, pig farmers wash the floor by a high-pressure spray-washing method, but such method not only creates a burden of manpower, material, machine and work, but also wastes lots of water resources and increases wastewater and the workload of the wastewater treatment facility.

4. Since the wastewater produced by the daily cleanup of the livestock house increases a substantial increased of workloads of the wastewater treatment facility, the wastewater treatment facility requires expanding its equipments, site and machines, and thus incurring a higher expense. Sometimes, pig farmers dump the wastewater into river or reservoir illegally, and thus resulting in a poor water quality and a damage to the ecological environment.

In view of the aforementioned shortcomings, the inventor of the present invention based on years of experience in the related industry to conduct extensive researches and experiments, and finally designed an improved livestock house in accordance with the present invention to overcome the shortcomings of the prior art.

### SUMMARY OF THE INVENTION

It is a primary objective of the present invention to overcome the shortcomings of the prior art by providing an improved livestock house capable of providing an excellent dry environment to reduce the occurrence of diseases and any waste of feeds, improving the waste of manpower and materials for removing bad smells produced by animal manure and urine and removing the bad smells, as well as achieving the use of the livestock house with the economic, power-saving and environmental protection effects.

To achieve the foregoing objective, the present invention provides an improved livestock house comprising a slanted floor, a funnel-shaped slanted ditch connected to a lower end of the slanted floor, a hole board laid at a connecting position of the ditch and the floor, and a flush pipe installed at a front end of the ditch, such that the slanted floor can make an animal to excrete manure with its bottom facing downward involuntarily, and a large portion of the manure together with the animal urine can be flushed into the ditch directly through the hole board, or passed through a funnel-shaped slanted ditch and the hole board, and the manure entering into the ditch will become smaller, and the smaller manure can be collected by the urine or flushed by the water in the flush pipe to a low position of the ditch and discharged to a wastewater treatment facility. Therefore, the livestock house can maintain an excellent dry environment all the time. In the meantime, the invention can improve the hygiene and sanitation problems by removing bad smells produced from the animal manure and urine, removing stinky wastewater, and maximizing the economic, power-saving and environmental protection effects.

To make it easy for our examiner to understand the objects, characteristics, and effects of the present invention, we use the following preferred embodiments accompanied with related drawings for the detailed description of the present invention as follows:

### BRIEF DESCRIPTION OF THE DRAWINGS

FIG. 1 is a perspective view of a conventional livestock house;

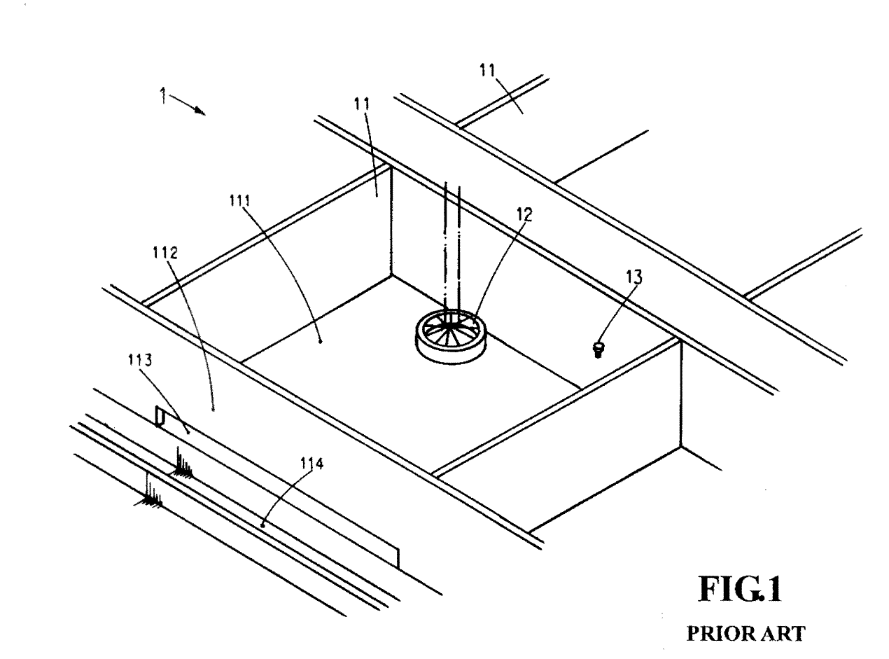

FIG. 2 is a top view of a livestock house in accordance with a preferred embodiment of the present invention;

FIG. 3 is a cross-sectional view of Section A-A of FIG. 2;

FIG. 4 is a cross-sectional view of Section B-B of FIG. 2; and

FIG. 5 is a schematic view of a livestock house of FIG. 2 without laying a hole board in the livestock house.

### DETAILED DESCRIPTION OF THE PREFERRED EMBODIMENTS

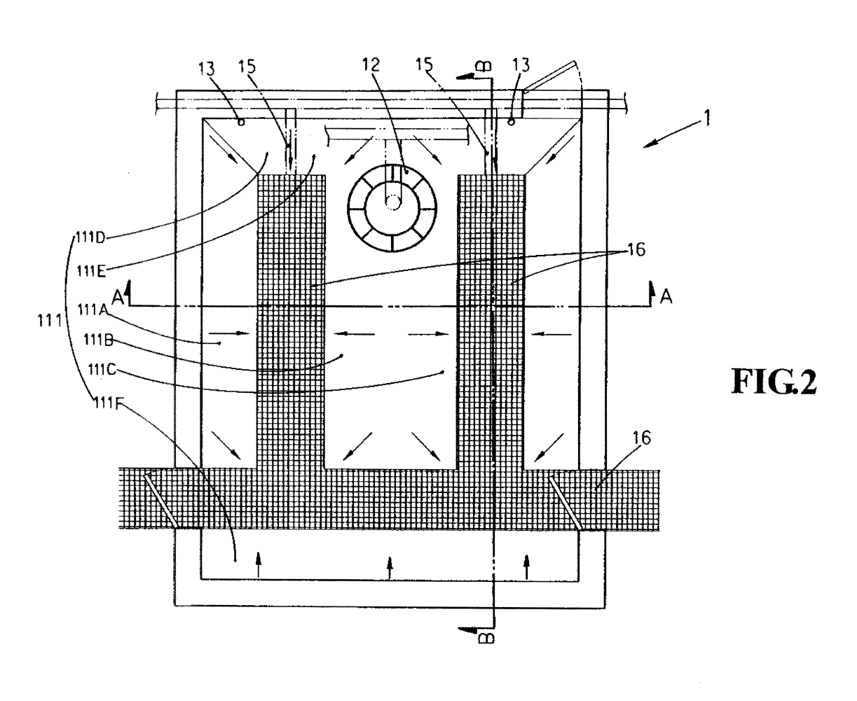

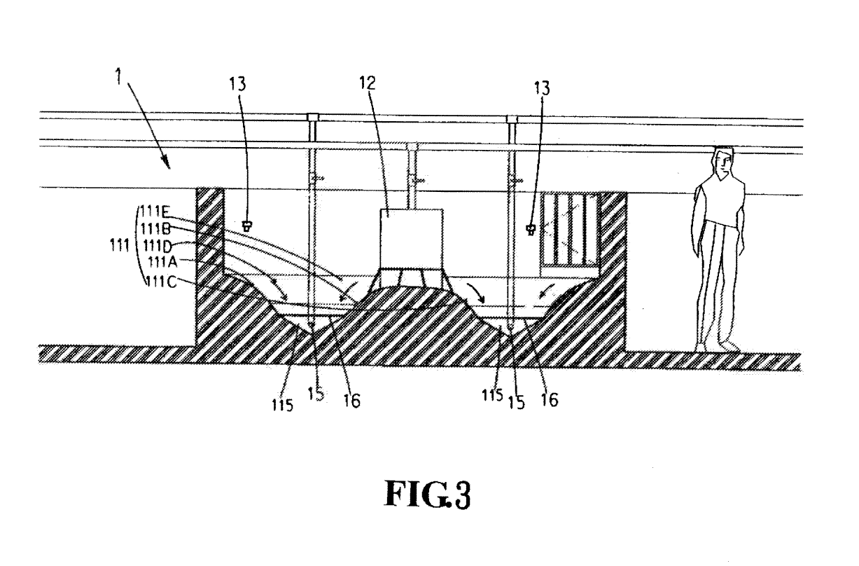

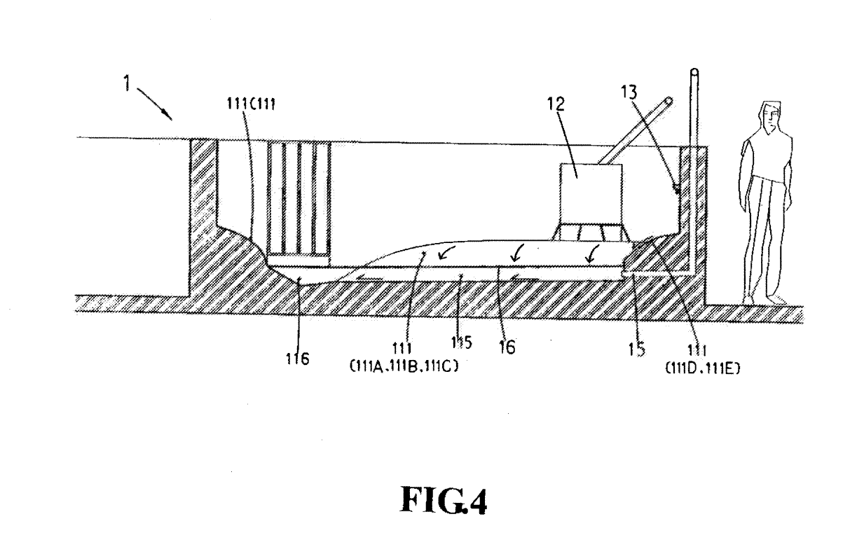

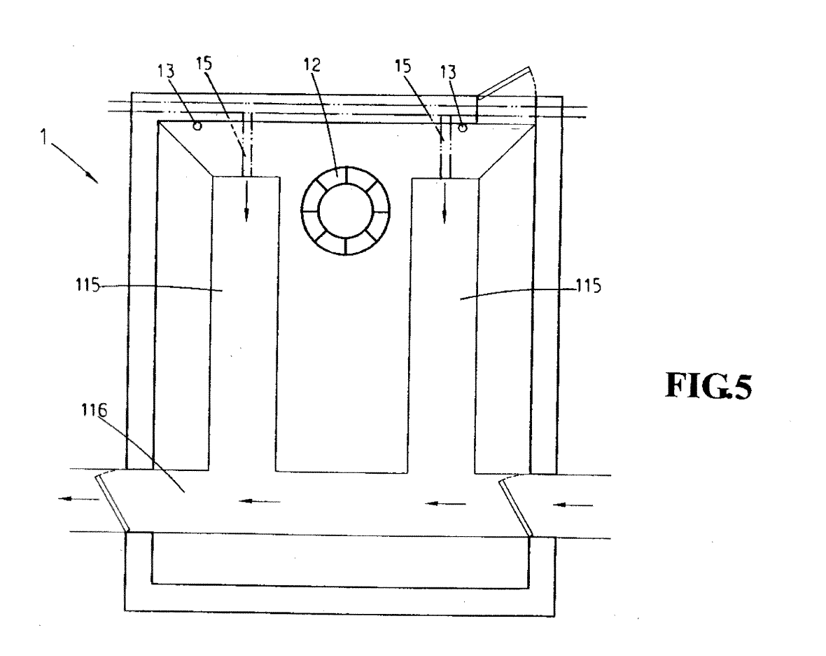

With reference to FIGS. 2 to 5 for an improved livestock house of the present invention, the livestock house 1 for raising livestock comprises a slanted floor 111, at least one slanted surface 111A, 111B, 111C, 111D, 111E, 111F, . . . formed on the slanted floor 111 according to the space and size of the livestock house 1, a funnel-shaped ditch 115 coupled to a lower end of the slanted floor 111 (including the slanted surfaces 111A, 111B, 111C, 111D, 111E, 111F . . . ), and tilted downwardly from front to rear, and a flush pipe 15 connected to a high position at the front of the funnel-shaped ditch 115, wherein a low position at the rear of the funnel-shaped ditch is coupled to a main ditch 116, and the main ditch 116 are slanted. In addition, a hole board 16 is laid on a connecting position of the ditch 115 and the slanted floor 111 for covering the ditch 115 completely and precisely.

A feeding trough 12 and a drinking water dispenser 13 are arranged at high positions or above the slanted floor 111.

The flush pipe 15 is connected to a wastewater treatment facility (not shown in the figure) and provided for drawing filtered and purified wastewater. The hole board 16 has a plurality of holes in any shape and the holes are penetrated through the hole board 16.

The funnel-shaped ditch 115 has two sidewalls which are slanted and intersected at the lowest point of the funnel-shaped ditch 115 for collecting water liquids, and the two sidewalls are preferably in a V-shape.

The slanted main ditch 116 has a shape identical to the ditch 115, and the slanted main ditch 116 is connected to lower ends of the ditches 115 one by one, and the lower end of each ditch 115 is connected to a wastewater treatment facility.

In the present invention, the floor 111 of the livestock house 1 comes with a slanted surface, and the funnel-shaped ditch 115 is connected to a lower end of the slanted floor 111, and a hole board 16 is installed at a connecting position of the ditch 115 and the slanted surface of the floor 111. According to the habits and activities of animals, the slanted floor 111 makes the bottom of pigs or other animals to face downward involuntarily to excrete manures, such that a large portion of the manures will be drained together with urines through the holes of the hole board 16 and entered into the ditch 115 successfully, so as to achieve the effect of reducing excrements from remaining on the slanted floor 111. Since the hole board 16 is arranged at a low position of the slanted floor 111, therefore the manure not excreted directly' on the hole board 16 but situated on the slanted floor 111 will roll down to the hole board 16 by means of the slanted floor 111 and fall into ditch 115 through the holes, or the urine will flow down quickly due to the slanted floor 111 to wash away the manure to the hole board 16 and the ditch 115, so as to achieve the effect of further reducing the manure at the slanted floor 111.

Since the drinking water dispenser 13 is installed at a high position or above the slanted floor 111, any water spilled during the drinking of the livestock will flow along the slanted floor 111 into the ditch 115, and the spilled water will not be accumulated. Therefore, the slanted floor 111 can be dried quickly, and the water flowing along the slanted floor 111 and the spilled water can provide a cleaning effect. With the slanted ditch 115, the spilled water provides a better washing and cleaning effect to the ditch 115.

Since the slanted floor 111 drives most of the excreted manures into the hole board 16 and the ditch 115, and the urine and spilled water will flow into the ditch 115 quickly, therefore the quantity of manures remained on the slanted floor 111 becomes less and drier. In addition, the body temperature of the gathered animals can dry the small quantity of the drier manures quicker or turns them into a powder or granule form. Naturally, the slanted floor 111 and the continuous activities of the animals drive the manures in the powder or granule form to roll and fall into the ditch 115 automatically, and the animal urine or spilled water can wash the manures into the main ditch 116 and a wastewater treatment facility (not shown in the figure) quickly, so as to achieve the effect of maintaining the slanted floor 111 dry and clean all the time.

Since the funnel-shaped slanted ditch 115 and the slanted surfaces on both sides of the main ditch 116 can collect and guide the animal urine and spilled water to a low position, therefore the collected water liquid and urine can produce a powerful washing force and a high flow speed to discharge the manure to the wastewater treatment facility, and the ditches 115, 116 can be maintained much drier to prevent bad smells produced by the fermentation of the manures. With the operation of discharging water through the flush pipe 15, the manure remained in the ditch 115 or the main ditch 116 can be flushed to the wastewater treatment facility more quickly and smoothly to achieve the effect of removing excrements quicker. In other words, the funnel-shaped ditch 115 and the slanted surfaces on both sides of the main ditch 116 drive the animal manure and urine to a low position of the slanted ditch 11 automatically. and the flush pipe 15 is arranged at a high position of the slanted ditch 115, so that the manure remained in the ditch 115 and the main ditch 116 can be washed away smoothly and quickly by the water discharged from the flush pipe 15 to achieve the simple, easy, and convenient cleaning effect.

Since the flush pipe 15 is connected to the wastewater treatment facility, therefore the water liquid used for flushing the ditch 115 is the water primarily comes from the wastewater that has been filtered and purified by the wastewater treatment facility, instead of clean drinking water. In addition, livestock farmers can pump the wastewater periodically or non-periodically to flush the ditch 115, so as to achieve the economic effect of saving clean water as well as cleaning the livestock house anytime. Of course, the wastewater purified by the wastewater treatment facility is simply provided for flushing the ditch 115, but not for washing and cleaning the livestock. The slanted ditch 115 can drive the discharged wastewater and manure through the main ditch 116 to the wastewater treatment facility quickly and prevent them from being accumulated, so that the flush of water from the flush pipe 15 will not jeopardize the animal's health. On the contrary, the ditch 115 can be cleaned appropriately, and wastewater will not remain, and the invention can achieve the effects of improving the environmental hygiene of the livestock house and reducing the occurrence of diseases.

The slanted floor 111 will not hold accumulated water and will be kept dry all the time. The feeding trough 11 is arranged at a high position of the slanted floor 111, such that the floor around the feeding trough 11 can be kept dry all the time, and the feeds spilled on the floor can be kept dry as well. Therefore, the animals may eat the dry feeds spilled on the floor, and thus achieving the economic effect of avoiding any waste of feeds intangibly.

In other words, the livestock house floor of the present invention provides an excellent dry environment, and the dry floor can reduce the occurrence of diseases and the waste of feeds effectively, and the animal manure and urine can be discharged to the wastewater treatment facility timely and quickly, and the bad smells produced by the fermentation of the mixed manure and urine can be improved or even eliminated. The improvement or removal of the bad smells of the livestock house further improves and reduces the production of ammonia and nitrogen and thus preventing the stinky smell from being accumulated in the animal's body, so as to improve the meat quality of the livestock. The present invention can achieve the effect of discharging animal manures, urines and excrements to the wastewater treatment facility timely and improving the bad smells produced by fermentations, so that it no longer needs to wash and clean the livestock house as often, and the invention can reduce the waste of water resources and achieve the economic effect. In addition, the invention can reduce the production of wastewater and the cost incurred for the wastewater treatment, and the wastewater can be recycled during the process of raising livestock.

What is claimed is:

1. An improved livestock house, comprising:
a slanted floor;
a funnel-shaped ditch, coupled to a lower end of the slanted floor, and titled downwardly from the front to the rear of the funnel-shaped ditch;
a flush pipe, installed at a high position of a front end of the funnel-shaped ditch;
a main ditch or a wastewater treatment facility, connected to a low position at a rear end of the funnel-shaped ditch; and
a hole board, installed at a connecting position of the slanted floor and the funnel-shaped ditch.

2. The improved livestock house of claim 1, wherein the slanted floor includes at least one slanted surface according to the space and size of the livestock house.

3. The improved livestock house of claim 1, further comprising a feeding trough and a drinking water dispenser arranged at high positions or above the slanted floor.

4. The improved livestock house of claim 1, wherein the flush pipe is connected to a wastewater treatment facility and provided for drawing and discharging wastewater to the ditch, after the wastewater is purified.

5. The improved livestock house of claim 1, wherein the funnel-shaped ditch includes two sidewalls which are slanted and intersected at the lowest point of the funnel-shaped ditch.

6. The improved livestock house of claim 5, wherein the funnel-shaped ditch preferably has a V-shaped cross-section.

7. The improved livestock house of claim 1, wherein the hole board includes a plurality of holes in any shape and penetrated into the ditch after the hole board is installed.

8. The improved livestock house of claim 1, wherein the main ditch is titled from the front to the rear and connected to lower ends of the ditches one by one, and the lower ends of the ditches are connected to a wastewater treatment facility.

9. The improved livestock house of claim 8, wherein the main ditch has a shape identical to the funnel-shaped ditch and preferably having a V-shaped cross-section.
